(19) United States
(12) Patent Application Publication
(10) Pub. No.: US 2025/0080487 A1
(43) Pub. Date: Mar. 6, 2025

(54) ELECTRONIC MAIL SYSTEM WITH FORWARDING TRACKING AND CONTROL

(71) Applicant: VOTP INC., LEESBURG, VA (US)

(72) Inventor: THEODORE SJURSETH, LEESBURG, VA (US)

(73) Assignee: VOTP INC., LEESBURG, VA (US)

(21) Appl. No.: 18/459,141

(22) Filed: Aug. 31, 2023

(51) Int. Cl. H04L 51/42; H04L 51/234

(52) U.S. Cl. CPC H04L 51/42; H04L 51/234

(57) ABSTRACT

A digital letters system performs a method. The method includes storing, in a digital letters database, a first digital letter created by an author who is a subscriber to the digital letters system. The method includes communicating an image of the first digital letter to a recipient subscriber device while the first digital letter itself remains as a single copy in the digital letters database. The image of the first digital letter is communicated in response to the author subscriber selecting to send the first digital letter to the recipient subscriber, and the recipient subscriber selecting to view the first digital letter stored on the digital letters database.

### TECHNICAL FIELD

The technical field of the present disclosure relates to network-based digital communication, and more specifically to secure network-based messaging systems with messaging control.

### BACKGROUND

Email, text messaging, instant messaging (a form of text messaging), and other forms of network-based digital communication and messaging are in widespread use worldwide, over various networks including cellular networks, local area networks (LANs), wide area networks (WAN), and the globally connected network known as the Internet, for a wide range of user devices including computers, smart phones, personal data assistants (PDAs), etc. There are many apps (applications) used for network-based digital communication, including email apps, browser apps, and text messaging apps. Data security, data control and data access are ongoing interests and concerns in network-based digital communication, and there is an ongoing need in the art for improvements to the technology.

### SUMMARY

Described herein are embodiments of a digital letters system, a method and a computer-readable media. The embodiments and variations thereof relate to a digital letters system that stores a single copy of a digital letter in a database, and provides access to that single copy to other users of the system. Various features of the digital letters system and operation thereof, such as restricting the number of views of a digital letter and/or restricting the ability of an initial recipient to allow further downstream recipients to access the digital letter (“forwarding control”), are implemented by controlling access to the single copy of the digital letter stored in the database. Features may be implemented in subscriber to subscriber communication embodiments, subscriber to non-subscriber communication embodiments, embodiments with differing features for subscriber to subscriber communication and subscriber to non-subscriber communication, and embodiments with similar features for subscriber to subscriber communication and subscriber to non-subscriber communication, etc.

Users of the digital letters system can be either subscribers or non-subscribers (“visitors”). Subscribers are individuals who have registered with the system and therefore have accounts within the system. Non-subscribers are individuals who have not registered with the system and therefore do not have accounts within the system, but nonetheless are able to view secure communications sent by subscribers. Only subscribers can be authors (creators) of digital letters within the system. An author can create and provide access to a digital letter to both subscribers and non-subscribers alike, yet still control the number of times that any given recipient can view the digital letter, and also control that recipient's ability to “forward” the digital letter by providing access to further downstream recipients.

In one embodiment, a digital letters system has a network-connectable server, a digital letters database, and a processor configured to control access to digital letters stored in the database. The processor is configured to communicate an image of a first digital letter, created by an author and residing in the digital letters database, to a subscriber device (“subscriber-recipient device”), while the first digital letter itself remains as a single copy in the digital letters database. In this scenario, the author and the subscriber are both registered with the digital letters system. The processor is further configured to communicate an email or text message including a link to a second digital letter residing in the digital letters database, to a non-subscriber device (“non-subscriber-recipient device”). Selecting the link on the non-subscriber device causes an image of the second digital letter to appear on the non-subscriber device while the second digital letter itself remains as a single copy in the digital letters database. In this scenario, while the author is a subscriber, the non-subscriber is a visitor and thus not registered with the digital letters system.

One embodiment is a processor-based method of operation of a digital letters system. The method includes communicating an image of a first digital letter, created by an author and residing in the digital letters database. The image of the first digital letter is communicated to a subscriber device (“subscriber-recipient device”). The image of the first digital letter appears on the subscriber device while the first digital letter itself remains as a single copy in the digital letters database. In this scenario, the author and the subscriber are both registered with the digital letters system. The method includes communicating an email or text message including a link to a second digital letter, created by the author and residing in the digital letters database. The email or text message including the link is communicated to a non-subscriber device (“non-subscriber-recipient device”). Selecting the link on the non-subscriber device causes an image of the second digital letter to appear on the non-subscriber device while the second digital letter itself remains as a single copy in the digital letters database. In this scenario, while the author is a subscriber, the non-subscriber is a visitor and thus not registered with the digital letters system.

In one embodiment, a tangible, non-transitory, computer-readable media has instructions thereupon which, when executed by a processor, cause the processor to perform a method. The method includes communicating an image of a first digital letter, created by an author and residing in the digital letters database. The image of the first digital letter is communicated to a subscriber device (“subscriber-recipient device”). The image of the first digital letter appears on the subscriber device while the first digital letter itself remains as a single copy in the digital letters database. In this scenario, the author and the subscriber are both registered with the digital letters system. The method includes communicating an email or text message including a link to a second digital letter, created by an author and residing in the digital letters database. The email or text message including the link is communicated to a non-subscriber device (“non-subscriber-recipient device”). Selecting the link on the non-subscriber device causes an image of the second digital letter to appear on the non-subscriber device while the second digital letter itself remains as a single copy in the digital letters database. In this scenario, while the author is a subscriber, while the non-subscriber is a visitor and thus not registered with the digital letters system.

In another aspect, the present invention contemplates a system, method and computer readable medium for displaying a novel user interface on an author subscriber device. The novel user interface has at least a window or region for composing a message; and selectors (e.g., soft buttons, fillable fields, pull-down menus, etc.) which, when selected by an author, prevent a recipient from forwarding the digital letter to others, restrict the recipient to a single view, and/or restrict the recipient to a predetermined umber of views.

For example, a server-based method of operation of a digital letters system, may comprise (a) generating, by a server of the digital letters system, a user interface for a subscriber to author and send a digital letter to a recipient subscriber, wherein the digital letter is to be stored in a digital letters database accessible by the server; and (b) communicating, by the server, the user interface from the digital letters system to an author subscriber device, causing the user interface to appear on the author subscriber device for the subscriber to author and send the digital letter, wherein the user interface has a digital letter composition region, a one time view selector operable to restrict number of views of the digital letter by the recipient subscriber, and a send with no forwarding selector operable to prevent forwarding of the digital letter by the recipient subscriber.

The system and computer readable media implementations for the novel user interface invention can be similarly described.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram showing multiple systems, with user devices connected via a network to a digital letters server that implements an embodiment of a digital letters system.

FIG. 2 illustrates an embodiment of digital letters servers.

FIG. 3 illustrates a digital letters website screen, as seen on a user device in an embodiment.

FIG. 4 illustrates a digital letters sign in screen, as seen on a user device in an embodiment.

FIG. 5 illustrates a digital letters personal account screen, as seen on a user device operated by a subscriber with example name Subscriber01, showing the inbox and a selector to create a letter, in an embodiment.

FIG. 6 illustrates a further digital letters personal account screen, as seen on a user device operated by a subscriber with example name Subscriber02, in an embodiment.

FIG. 7 illustrates a digital letter composition screen, as seen on a user device operated by a subscriber with example name Subscriber02, in an embodiment.

FIG. 8 illustrates an email that includes a link to a digital letter, as seen on a user device in an embodiment.

FIG. 9 illustrates a message that includes a link to digital letter, as seen on a smart phone (e.g., a type of user device) in an embodiment.

FIG. 10 illustrates an image of a digital letter, as seen in a digital letters visitor's portal, through a browser as seen on a user device operated by a non-subscriber with example name Non-subscriber01, in an embodiment.

FIG. 11 illustrates an image of a digital letter, as seen in a digital letters user's portal, through a browser and screen on a user device operated by a subscriber with example name Subscriber02, in an embodiment. Various selectors show limited options for replying, and no forwarding.

FIG. 12 illustrates an image of the digital letter, showing multiple recipients and various selectors for options available to a digital letters user, including forwarding, in an embodiment. The image of the digital letter is seen on a digital letters user's portal, through a browser and screen on a user device operated by a subscriber with example name Subscriber02.

FIG. 13 illustrates forwarding of a digital letter, with information of the forwarding chain as seen through a browser on a user device operated by a subscriber with example name Subscriber02, in an embodiment.

FIG. 14 is a flow diagram that illustrates a method of operation of a digital letters system according to an embodiment.

### DETAILED DESCRIPTION

Described herein are embodiments of a digital letters system, and variations thereof, that has similarities with email and text messaging but offers features and improvements thereupon. A digital letter, resembling an email or a text message, can be sent to a subscriber of the digital letters system with control and various options for the recipient, and can be sent to a non-subscriber of the digital letters system with control and limited options for the recipient. One time view (OTV), other view count limits, forwarding control, recipient and forwarding tracking, groups and group membership are some of the features available in various embodiments. Storage of each digital letter as a single (or singular) copy in a corresponding private digital letters box in a database is a central feature that provides control over how many times an image of a digital letter can be viewed, and allows deletion or access control of the single copy of the digital letter even when the digital letter is forwarded to one or multiple recipients.

Contrasting the digital letters system with traditional email is informative and suggests some technological problems that are solved in present embodiments. Sending an email to multiple recipients, forwarding an email to multiple recipients, or forwarding an email in a chain to a series of recipients, and combinations of these activities, results in many copies of the email being “out there”, and generally no control over where those copies go, who views them or how many times they are viewed. With the digital letters system, deleting or controlling access to the single copy of the digital letter prevents further viewing of the digital letter. This is because each recipient has a pointer to the digital letter and can view an image of the digital letter only when authorized by the digital letters system, but the recipient does not have a copy of the digital letter. Sending that pointer to another recipient, if not as selectably allowed and tracked in the digital letters system, results in that next recipient being unable to view the digital letter, i.e., the digital letters system controls and denies access by declining to send an image of the digital letter. Or, selecting that pointer multiple times if that exceeds the view count limit, results in that recipient being unable to further view the digital letter, through related control of access. The digital letters system controls access to the single copy of the digital letter stored in the digital letters database, by determining whether to send or not send an image of the digital letter, and thereby controls authorized viewing and prevents unauthorized viewing. Described below are various embodiments that show mechanisms for such view control, applied towards one time view, other view count limits, forwarding control and further features in various combinations.

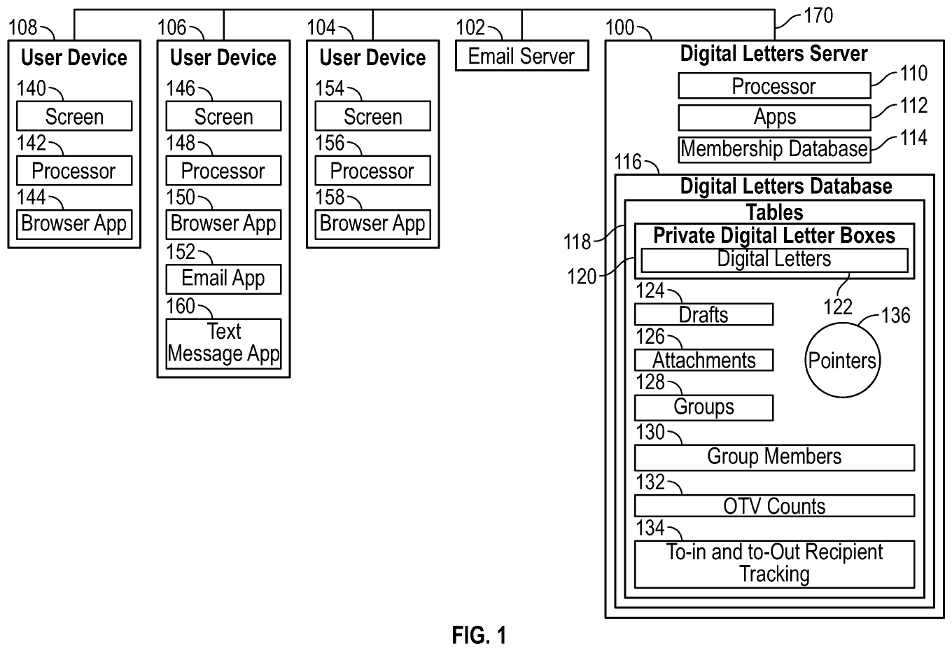

FIG. 1 is a system diagram showing multiple systems, with user devices 104, 106, 108 (e.g., computers, smart phones, other network-connectable communications devices, etc.) connected via a network 170 to a digital letters server 100 that implements an embodiment of a digital letters system. There is also an email server 102 depicted, which is used for communicating emails with links. There could also be a text messaging server, used for communicating text messaging with links, not depicted but readily understood. It is intended broad network connectivity capabilities are assumed, e.g. through wired or wireless networks, intranets, the Internet, etc., and a wide variety of user devices including computers, smart phones, etc. with a wide variety of apps are assumed, so that the devices and connections illustrated herein serve as examples but are not limiting for the embodiments.

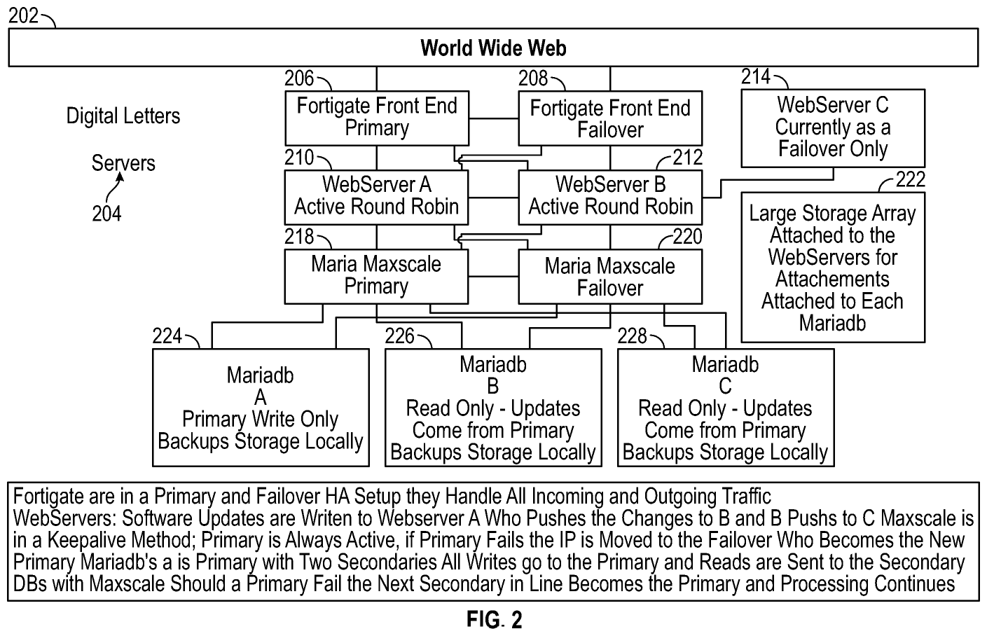

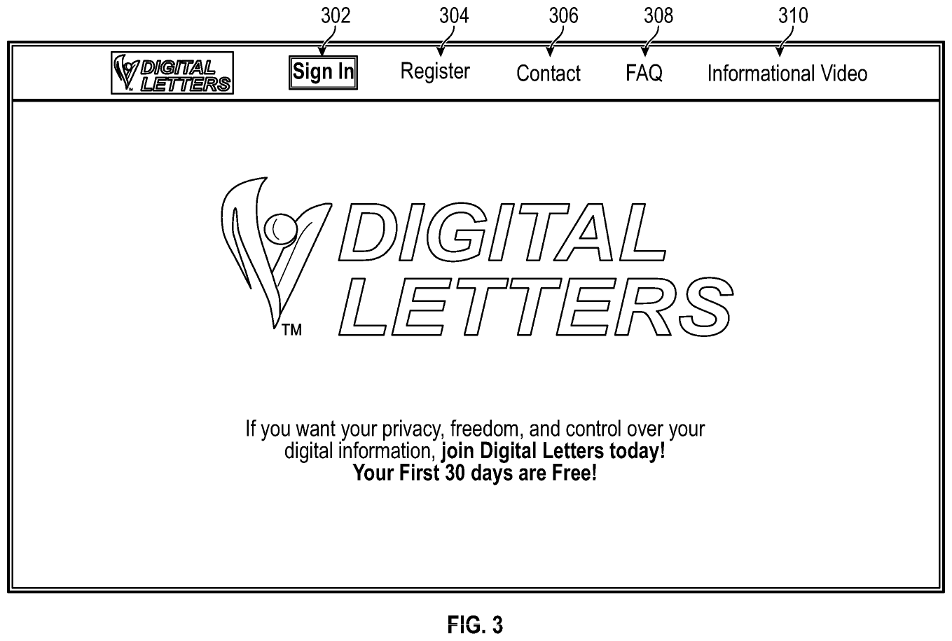

One user device 104, which could be used by a subscriber of the digital letters system and then termed a subscriber device, has a screen 154 (which could be a touchscreen but does not need to be), a processor 156, and a browser app 158 through which access is made to a digital letters website hosted by the digital letters server 100 (see FIGS. 2 and 3). Note that the user device 104 could also have an email app and/or a text message app, which are useful in some embodiments of the digital letters system, and not required in other embodiments of the digital letters system.

Another user device 106, which could be used by a subscriber of the digital letters system as a subscriber device, or used by a non-subscriber (e.g., visitor) and termed a non-subscriber device, has a screen 146, a processor 148, a browser app 150, and email app 152 and/or a text message app 160. Yet another user device 108, which could be used by a subscriber of the digital letters system, has a screen 140, a processor 142, and a browser app 144 through which access is made to the digital letters website.

Also contemplated, for a further embodiment, is a specially programmed digital letters app that is operable on a user device, for communication with the digital letters server, by a subscriber to the digital letters system. This could take the place of communication through a browser app 144 and access to the digital letters website as described above. A user device having such an app is an alternative embodiment of a subscriber device.

Any embodiment of a subscriber device can function as an author subscriber device and/or a recipient subscriber device, for authors and recipients of digital letters, respectively. Various user devices can function as a non-subscriber device, for a recipient non-subscriber, and may be termed a recipient non-subscriber device.

An email server 102 is connected to the network 170, and is used for communication with non-subscribers (a.k.a. visitors) of the digital letters system, and may also be used for communication with subscribers of the digital letters system in some embodiments and not others.

The digital letters server 100 is connected to the network 170, and includes a processor 110, apps 112, a membership database 114 for subscribers, and the digital letters database 116. One or more of the apps 112 executes on the processor 110 to operate the digital letters system, including accesses to the membership database 114, the digital letters database 116, and communications with user devices 104, 106, 108 and the email server 102. Suitable formats for the digital letters, e.g. a text format including font size and font type which may be default or selectable, and for the images of digital letters, e.g., image formats such as PNG, JPEG, GIF, TIF, PDF, raster, vector, etc., with or without compression, are readily applied in various embodiments and used in the data handling, communication and storage processes of the digital letters server 100 and related system components, and also in user devices and communication via the network 170.

Inside the digital letters database 116 are tables 118, including private digital letters boxes 120, drafts 124, attachments 126, groups 128, group members 130, view counts 132 (including OTV or one time view), and recipient tracking 134. Pointers 136 are used for associating or linking, and accessing various entries in various tables 118, including the digital letters 122 themselves. Digital letters 122 are stored in individual private digital letters boxes 120 and can be associated through pointers 136 to drafts 124, attachments 126 and subscribers that are members of a group, through group members 130 and groups 128. Digital letters 122 are also associated to view counts 132 on a per digital letter and per subscriber or non-subscriber view basis. This includes view count limits, as established by an author or forwarding recipient of a digital letter, and cumulative number of views of a digital letter as tracked in association with a recipient. For example, each view count limit for a digital letter could be stored as a parameter, and each view count of cumulative number of views of that digital letter stored as a further parameter and/or implemented as a counter (e.g., the count value on the counter is the value of the parameter). Digital letters 122 are associated to recipient tracking 134, which tracks digital letters addressed to a recipient and the inbox of that recipient, and digital letters composed by a sender or author and the recipient to whom a digital letter is sent (i.e., out), as to-in and to-out recipient tracking 134. Recipient tracking applies to both subscribers and non-subscribers. Groups 128 and group members 130 are associated to the membership database 114, which could include user information such as user IDs, passwords, user email addresses, payment information including credit cards, credit or debit accounts, etc. User IDs are used for digital letters communicated to and from users in the digital letters system, and email addresses are used for communication to non-subscribers (or, visitors) outside of the digital letters system, as further described below in operation scenarios.

FIG. 2 illustrates an embodiment of digital letters servers 204. In this example, the digital letters server 100 is implemented with multiple digital letters servers 204, and further variations are readily devised. Functionality, programming, memory, etc. of the digital letters system can be combined into a single server, spread out in multiple servers, implemented with virtual computing and/or virtual storage on physical hardware, etc., in various embodiments.

Here the front end of the server that couples to the World Wide Web 202 is implemented with a Fortigate front end primary server 206 coupled to a Fortigate front end failover server 208, with the pair of Web servers acting as a high availability (HA) set up that handles all incoming and outgoing traffic. This front end is coupled to WebServer A 210 and WebServer B 212 operating in active round robin, with WebServer C 214 as a failover. Software updates are written to WebServer A 210, with changes pushed to WebServer B 212 and from there to WebServer C 214. These are coupled to database servers Mariadb A 224, the primary write only, Mariadb B 226 read only, and Mariadb C 228 read only, as primary and two secondaries all with backup storage locally. A large storage array 222 is attached to the Web servers for attachments 126 (see FIG. 1 and examples of digital letters with attachments).

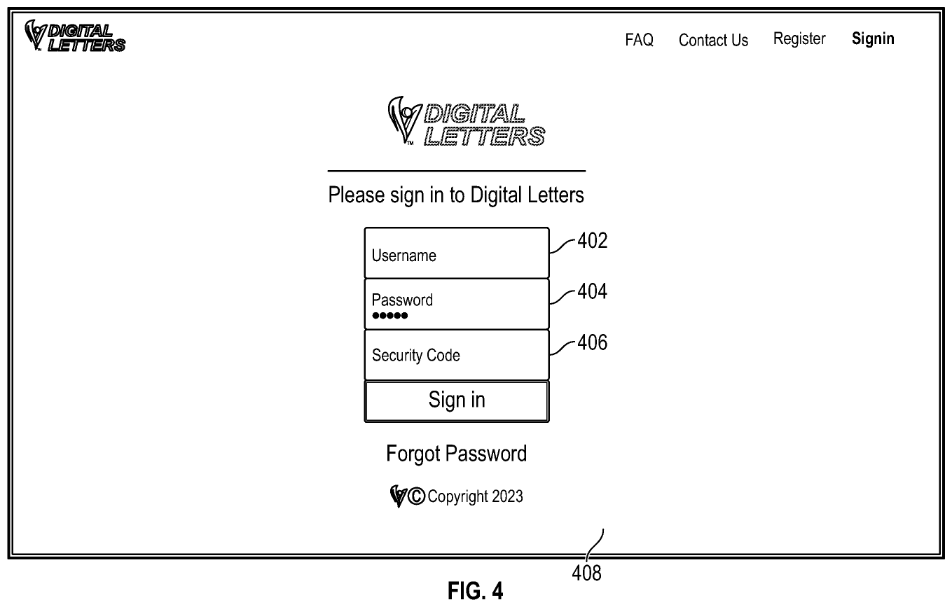

FIG. 3 illustrates a digital letters website screen, as seen on a user device in an embodiment. For an example operation scenario, user device 104 (see FIG. 1) accesses the digital letters website, hosted by the digital letters server 100, which communicates the digital letters website screen to the user device 104, for display on the screen 154 using the browser app 158. At the top of the digital letters website screen are seen the sign in 302 selector, register 304 selector, contact 306 selector, FAQ 308 (frequently asked questions) selector, and informational video 310 selector. These selectors can be implemented as soft buttons on a user interface (or fillable fields or drop-down menus or the like in further embodiments, e.g., using HTML coding, PHP, JavaScript, etc.), so that a user clicking on a soft button or otherwise indicating a selection selects the desired function. The digital letters server 100 receives such selection (i.e., activation of a selector is an event communicated over the network to the server) and communicates back to the user device 104, for example sending a change to the screen or a new screen for display on the screen 154 of the user device 104, through the browser app 158. This operating scenario continues to FIG. 4, with the user selecting sign in 302. Related operation is understood in the below further description. User interfaces, generated by a server, are readily implemented for example through appropriate computer programming by one skilled in the art, to form the various screens and features described herein.

FIG. 4 illustrates a digital letters sign in screen, as seen on a user device in an embodiment. There is a field for the subscriber to enter a username 402, a password 404 and a security code 406, and a sign in 408 selector. With this, the subscriber signs into digital letters and is able to make use of the various features described herein in various embodiments, through the subscriber device and the digital letters server 100 (see FIG. 1). Variations with other forms of authentication, and account set up, account recovery, etc., should be understood.

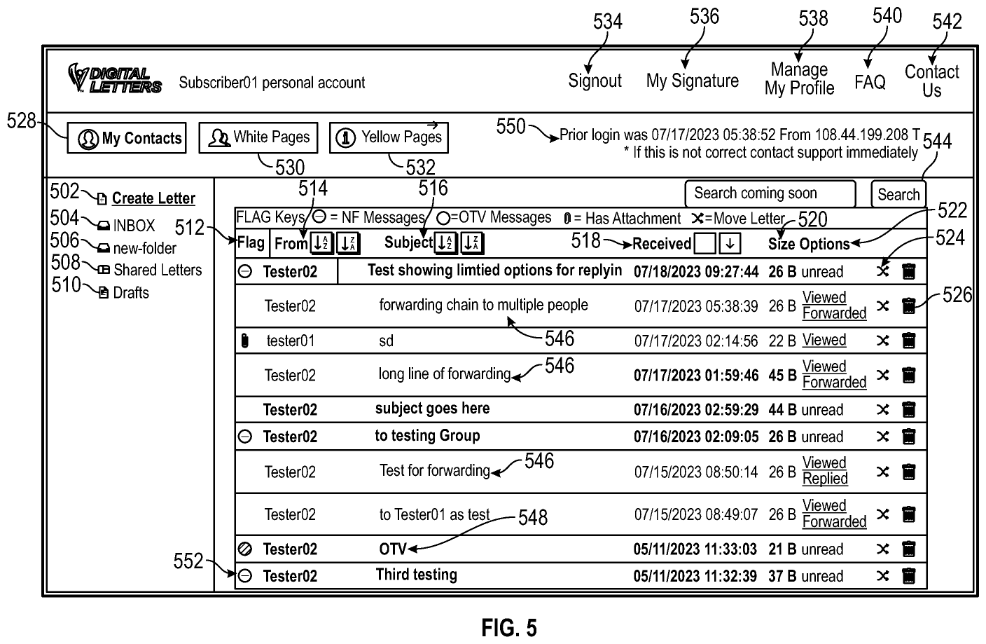

FIG. 5 illustrates a digital letters personal account screen, as seen on a user device operated by a subscriber with example name Subscriber01, showing the inbox 504 and a selector to create a letter 502, in an embodiment. In this example, the digital letters personal account shown on the screen of the subscriber device belongs to the digital letters subscriber, and indicates this by showing the name Subscriber01 along with the text “personal account”. The new-folder 506 selector opens up a new folder. The shared letters 508 selector shows shared letters, also termed an outbox. The drafts 510 selector shows drafts of digital letters (see FIG. 1 digital letters database tables contents). Flag 510 indicators are shown in the keys as NF messages (no forwarding), OTV messages (one time view), attachments (paperclip symbol), and crisscrossing arrows (move letter). Other flags and related functions are possible in various embodiments. The from 514 column shows senders of digital letters, who are subscribers and may be authors or forwarding recipients of digital letters. The subject 516 column shows subject lines of digital letters, the received 518 column shows date and time stamps of digital letters when received to the inbox, the size 520 column shows the size of each digital letter, the options 522 column indicates whether a digital letter is unread, viewed and/or forwarded, the move letters 524 selectors allow a digital letter to be moved (e.g., a pointer or record moved to a different folder), and the trashcan 526 selector deletes. In one embodiment, the sender of a digital letter has control over deletion of the single copy digital letter itself in the digital letters database, while the recipient(s) has control over deletion of access through receiving images of the digital letter(s), but not control over deletion of the single copy of the digital letter itself in the digital letters database. Thus, the sender of a digital letter may control viewing of the digital letter throughout the lifespan of any forwarding chain, but recipients may not. Alternatively, in an embodiment, each digital letters system subscriber forwarding a digital letter may control downstream viewing of that digital letter in the chain, through deletion and digital letters system tracking.

At the top left of the digital letters personal account screen, my contacts 528 selector shows other personally significant users available to contact with a digital letter. The white pages 530 selector shows a listing of individual users, while the Yellow Pages 532 selector shows a listing of commercial users. In various embodiments, these listings may be restricted to subscribers, or include subscribers and non-subscribers.

At the top right of the digital letters personal account screen, the sign out selector 534 causes a sign out, my signature 536 selector accesses a signature utility for creating and managing signature for digital letters, manage my profile 538 selector accesses a utility for managing the user profile, FAQ selector 540 accesses a utility for frequently asked questions, and contact us 542 selector opens a contact utility. A search 544 selector allows searching, for example by ID, subject, date or other search target.

The forwarding 546 feature is mentioned in the subject 516 column, as is the OTV 548 (one time view) feature. A prior login 550 indicator shows a timestamp for the login and suggests contacting support if this is incorrect (and might flag unauthorized account access). Several inbox entries show the NF 552 (no forwarding) flag, which applies to the corresponding digital letter.

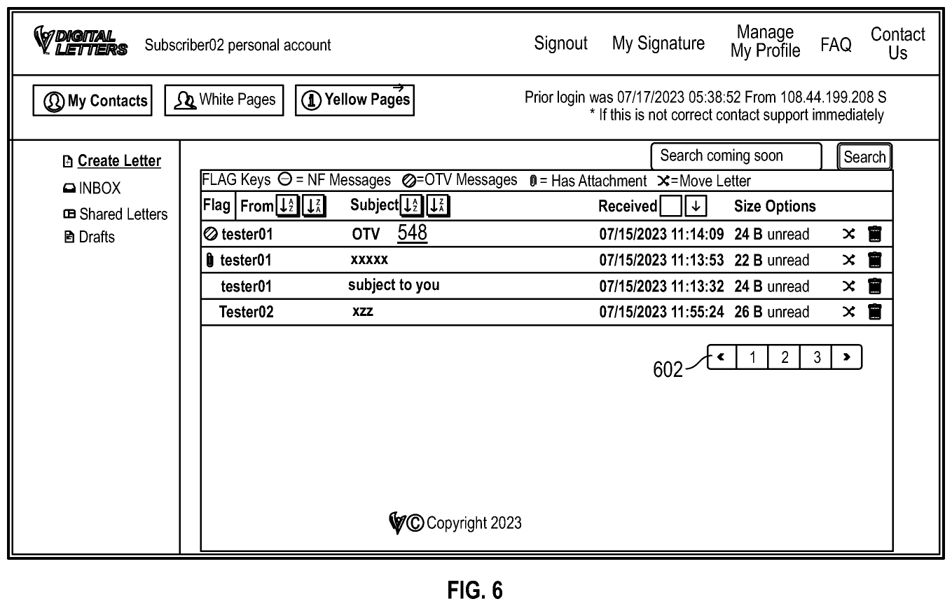

FIG. 6 illustrates a further digital letters personal account screen, as seen on a user device operated by a subscriber with example name Subscriber02, in an embodiment. In this example, the digital letters personal account shown on the screen belongs to the digital letters subscriber with the name Subscriber02, as indicated on the screen. OTV 548 is shown on one of the entries in the inbox, in the subject line. The entries show a number of digital letters from various subscribers, who may be authors or forwarding recipients. A page 602 selector allows selection of which page to view in the inbox.

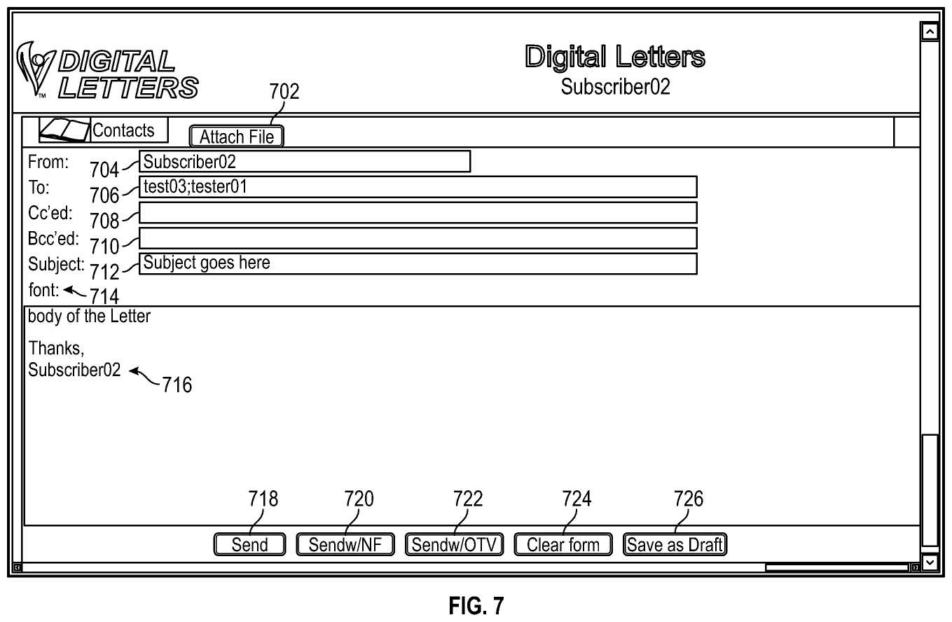

FIG. 7 illustrates a digital letter composition screen, as seen on a user device operated by a subscriber with example name Subscriber02, in an embodiment. In an operating scenario, the digital letter composition screen shows after subscriber selection of create a letter 502 (see FIG. 5). Here, the subscriber who is composing and sending a digital letter may be termed the author of that digital letter. Selecting attach file 702 (selector) allows the author to attach a file (see attachments 126 in FIG. 1). The from 704 field indicates a user ID of the sender, or more specifically the author, which appears auto filled since the author has selected to create a letter. The to 706 field is where the author enters recipient information, such as a user ID of a subscriber of the digital letters system, or an email address or associated ID for a non-subscriber of the digital letters system.

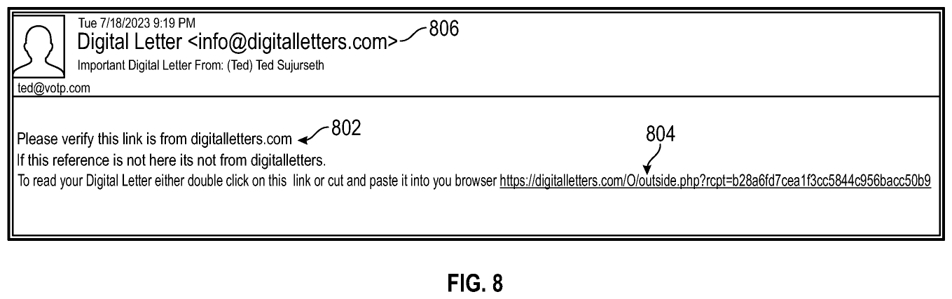

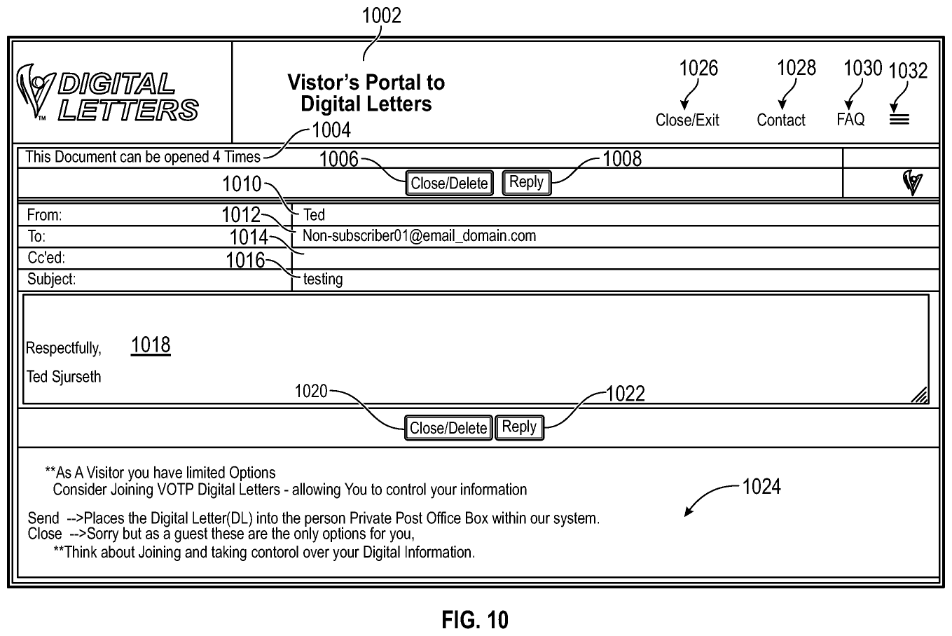

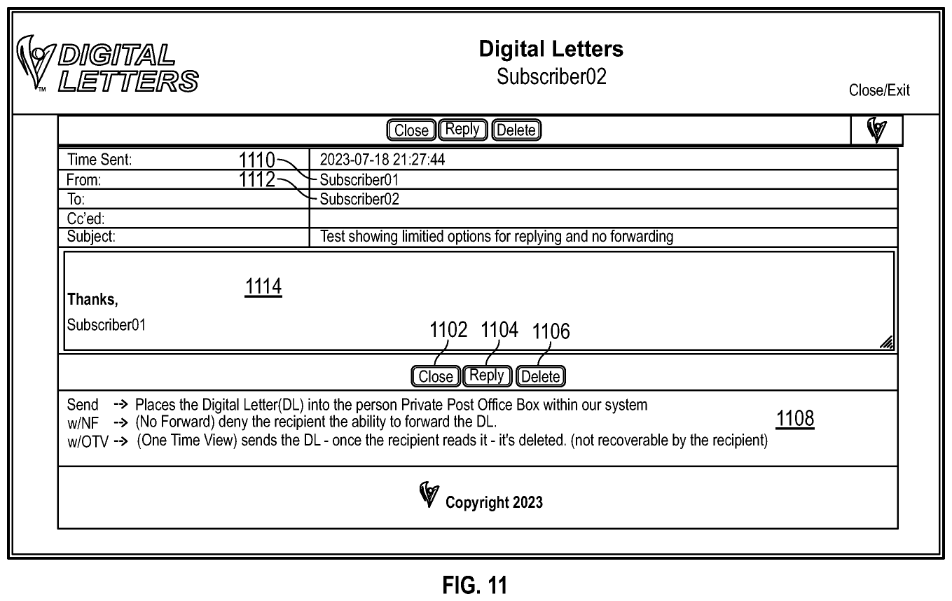

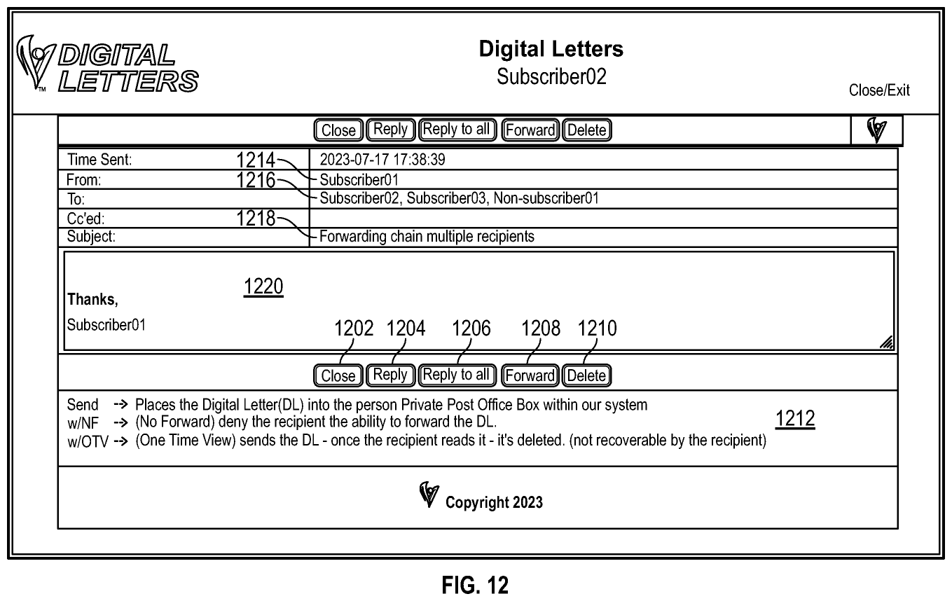

CC'ed 708 field is for entry of recipients to whom to send copies of the digital letter. Note one technicality, there is still only one digital letter stored in the tables 118 in the digital letters database 116, what is actually sent is a pointer, but the convention of CC (i.e., copy, copies, copying) from email terminology is used here for convenience. Similarly, Bcc'ed 710 field is for entry of recipients to whom to send blind copies of the digital letter, with same technicality applied. A recipient can be a subscriber, e.g., with delivery of the digital letter as depicted in FIGS. 11 and 12 or a non-subscriber, e.g., with delivery of the digital letter as depicted in FIGS. 8 and 10. Recipient types, subscriber and non-subscriber, can be mixed in any of the sending fields, e.g., to 706 field, CC′ed 708 field and Bcc′ed 710 field.

Subject 712 field is where the author enters a subject line. Font 714 selector allows selection of a font, which could include font type and font size, etc. The body of the letter 716 is entered by the user, much as one would compose an email. For example, suitable text formatting could be used for entry of the body of the letter 716, with the user operating a suitable input device for text or symbol entry. In this example, the author has signed with the subscriber name Subscriber02, which may be automated in some versions, manually entered in some versions, or selectable in some versions. A send 718 selector allows sending the digital letter without forwarding control. A send w/NF 720 selector (send with no forwarding) allows sending the digital letter with forwarding control, specifically no forwarding allowed. A send w/OTV 722 selector (send with one time view) allows sending the digital letter with one time view, i.e., limited view count. In further embodiments, there could be a selector for sending with a selected number of views, including one time view as a possibility. The clear form 724 selector clears the various fields, or in some embodiments clears a specified field. The save as draft 726 selector saves the digital letter as a draft (see drafts 124 in tables 118 in the digital letters database 116, FIG. 1).

FIG. 8 illustrates an email that includes a link 804 to a digital letter, as seen on a user device in an embodiment. In one operating scenario, the user of the user device 106 (see FIG. 1), is a non-subscriber or visitor of the digital letters system and does not have a digital letters system membership nor use the digital letters personal account screen (see FIGS. 6 and 7). A subscriber of the digital letters system has sent a digital letter to the non-subscriber or visitor, who receives the illustrated email, for example through the email app 152 displaying email on the screen 146 of the user device 106, also termed a non-subscriber device, because it is a user device 106 operated by a non-subscriber. In the email, there is sender information 806, showing this is regarding a digital letter originating through the digital letters system, with an address Digital Letter <info@digitalletters.com>, identified as Important Digital Letter From: (Ted) Ted Sjurseth. A note in the body 802 (i.e., a message) of the email suggests to verify the link, and suggests to paste the link 804 into a browser, to read the digital letter. Selecting the link 804 in the message that has appeared on the non-subscriber device causes an image of the digital letter to appear on the non-subscriber device, as further described with reference to FIG. 10.

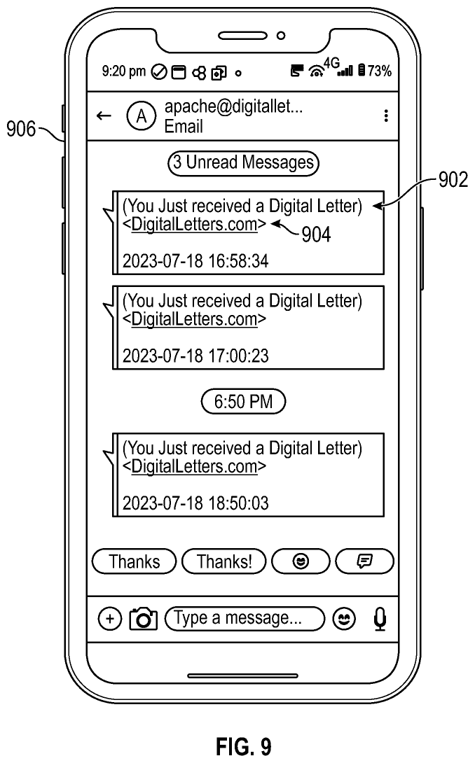

FIG. 9 illustrates a message that includes a link to digital letter, as seen on a smart phone 906 (e.g., a type of user device) in an embodiment. This scenario is an alternative to FIG. 8 and shows another way that a user of a user device, who is a non-subscriber or visitor of the digital letters system could be a recipient of a digital letter and receive a message 902 that includes a link 904 to that digital letter. Here a message 902 says, “(you just received a digital letter), accompanied by the link 904 and a date and time stamp. This could be accomplished through an email app 152, or alternatively a text message app 160 (see FIG. 1) on a user device 106 operated by a non-subscriber, i.e., a non-subscriber device. Selecting the link 904 in the message 902 that has appeared on the non-subscriber device causes an image of the digital letter to appear on the non-subscriber device, as further described with reference to FIG. 10. Each time the non-subscriber recipient selects the link 904 in the message 902, to view the image of the digital letter, the digital letters server 100 records an increment to the view count 132 associated with that digital letter (see FIG. 1), so that the digital letters server 100 can enforce the view count limit if applicable, e.g., view count limit selected by a sender using the digital letters system.

FIG. 10 illustrates an image of a digital letter, as seen in a digital letters visitor's portal, through a browser as seen on a user device operated by a non-subscriber with example name Non-subscriber01, in an embodiment. In this operating scenario, the user of the user device is not a subscriber of the digital letters system, but is a visitor, and has selected a link appearing in a message on a non-subscriber device (e.g. an email, a text message, etc., see FIGS. 9 and 10). Selecting the link causes the non-subscriber device to communicate with the website hosted by the digital letters server 100 (see FIG. 1), whereupon the digital letters server 100 sends an image of the specified digital letter to the non-subscriber device for display through the browser app 150 on the screen 146, e.g., of the user device 106. Here, the non-subscriber sees (in the image) the visitor's portal to digital letters 1002, a view count limit, “this document can be opened four times”, a close/delete selector 1006, a reply selector 1008, a from 1010 field showing the sender ID, a to 1012 field showing the recipient address, a CC′ed 2014 field (empty in this example but could be populated), a subject 1016 field with “testing”, the body 1016 of the message, a close/delete selector 1020, a reply 1022 selector, and a system message 1024. The system message 1024 may explain options available to the user, and invite membership, etc. There is no forward selector, and even if there were a text word “forward” present in the image, it would not be a live selector because this is an image, and the only live selectors are those programmed into the image as controlled by the sender and the digital letters server. There is thus no way for the non-subscriber to forward this digital letter. Even if the non-subscriber forwards the email that includes the link that points to the digital letter, to another recipient, and that other recipient selects the link to attempt to view the digital letter, the digital letters system recognizes that this other recipient is not the same as the non-subscriber recipient to whom the author of the digital letter originally sent the digital letter. Under those circumstances, making use of recipient tracking 134 (see FIG. 1), the digital letters system declines to send an image to that other recipient. Recall that the digital letter itself remains a singular copy in the private digital letters boxes in the digital letters database 116. This is how a digital letter sent to a non-subscriber of the digital letters system is prohibited from forwarding, and controlled as to the number of times it can be viewed.

FIG. 11 illustrates an image of a digital letter, as seen in a digital letters subscriber's portal, through a browser and screen on a user device operated by a subscriber with example name Subscriber02, in an embodiment. Various selectors show limited options for replying, and no forwarding. In this operating scenario, both the sender Subscriber01 indicated in the from 1110 field, who may be an author or a forwarding recipient, and the recipient Subscriber02 indicated in the to 1112 field, are subscribers of the digital letters system. Here, Subscriber02 is using a digital letters personal account screen (see FIG. 5), selecting to view a digital letter in the inbox 504, whereupon the subscriber views the image of the digital letter through the browser app 158 on the screen 154 of the subscriber device, e.g., user device 104 (see FIG. 1). The digital letter itself remains a singular copy in the private digital letters boxes in the digital letters database 116. In the image of the digital letter, there is a close 1102 selector, a reply 1104 selector, and a delete 1106 selector. A system message 1108 may explain options available to the recipient. In this example, there is no forward selector, as the sender (who may be an author or a forwarding recipient) has selected no forwarding. This is how the digital letter can be controlled and in this example, prohibited from forwarding. The digital letters server also is tracking each time the recipient views the image of the digital letter, by tracking selection for viewing from the inbox of the subscriber and using a view count as described above. This is how a digital letter can be sent to a subscriber of the digital letters system and prohibited from forwarding, and controlled as to the number of times it can be viewed. The body 1114 of the digital letter is as composed by the author, here Subscriber01.

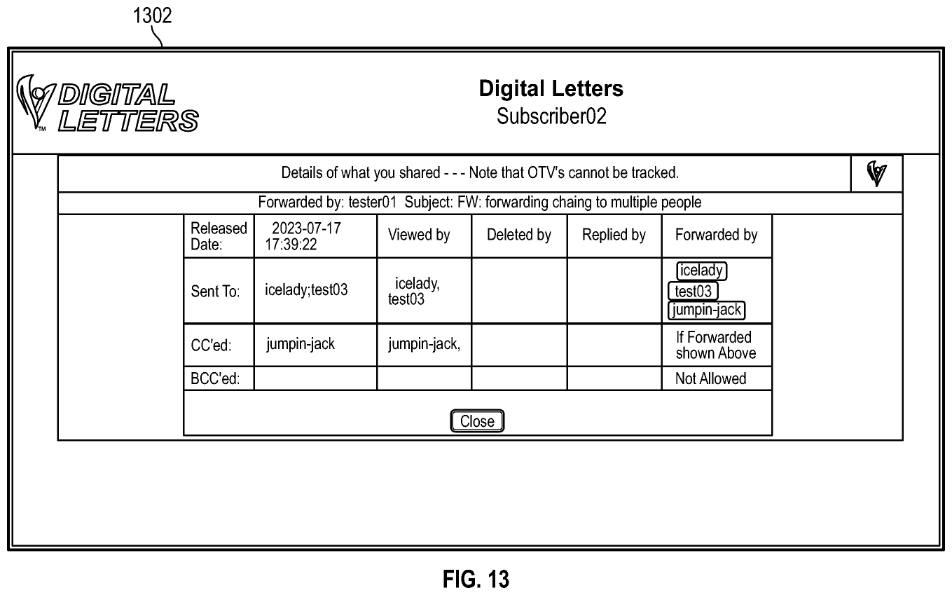

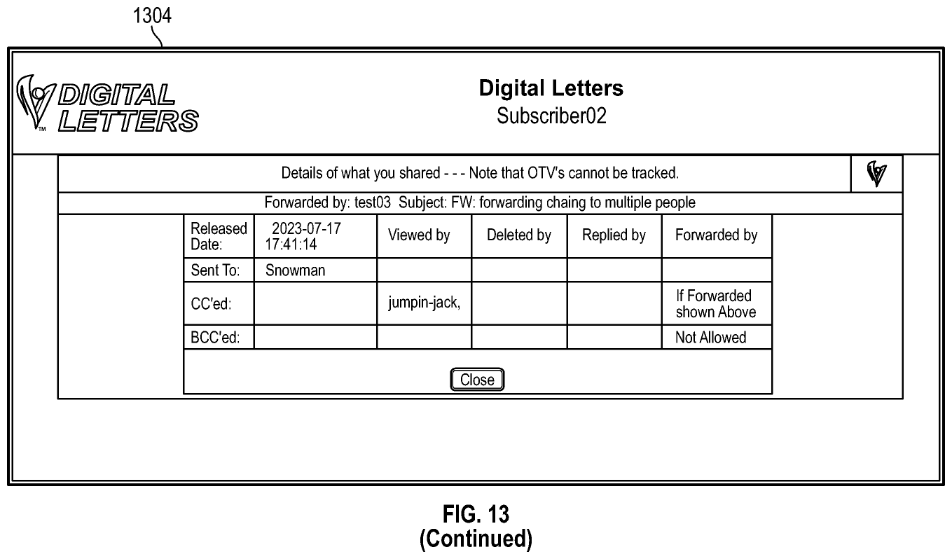

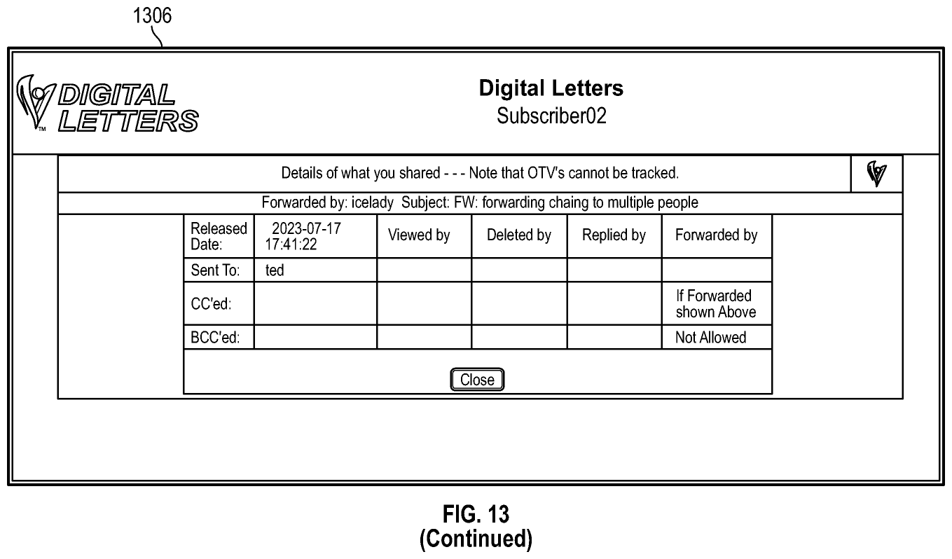

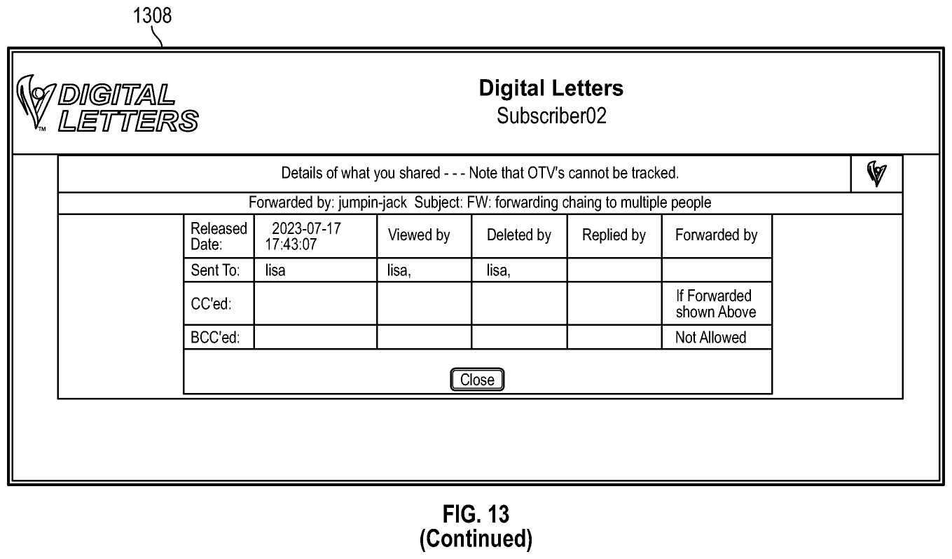

FIG. 12 illustrates an image of the digital letter, showing multiple recipients and various selectors for options available to a digital letters subscriber, including forwarding, in an embodiment. The image of the digital letter is seen by the recipient on a digital letters user's or subscriber's portal, through a browser and screen on a user device operated by a subscriber with example name Subscriber02. In this operating scenario, the digital letter is being forwarded in a forwarding chain to multiple people, as stated on the subject 1218 field, and the forwarding chain is described below with reference to FIG. 13. In the image of the digital letter, a close 1202 selector closes the image, a reply 1204 selector replies to sender of the digital letter, a reply to all 1206 selector replies to all users listed in association with that digital letter, a forward 1208 selector forwards the digital letter, and a delete 1210 selector deletes. It is appreciated that the author and/or forwarding recipient, has selected to allow forwarding in this example digital letter, which is why the forward 1208 selector is presented in the image of the digital letter.

FIG. 13 illustrates forwarding of a digital letter, with information of the forwarding chain as seen through a browser on a user device operated by a subscriber with example name Subscriber02, in an embodiment. Each forwarding screen 1302, 1304, 1306, 1308 seen on the subscriber device shows details of which subscriber forwarded, and to which recipient(s) the digital letter was forwarded, at each point in a forwarding chain. The screens also show which subscriber or non-subscriber recipient has viewed, which recipient has deleted, which recipient has replied, and which subscriber recipient has forwarded as specific details in a specific format of what was shared. Further embodiments could rearrange these details, i.e., change format, add or remove information, etc. The forwarding screen(s) are updated according to recipient activity tracked by the system. It should be appreciated that forwarding tracking and forwarding control is possible for subscribers of the digital letters system, which activity and selection the digital letters system logs in the digital letters database 116. But, the digital letters system has limited awareness of activity of non-subscribers of the digital letters system, which is why it is important to disallow non-users to forward a digital letter, and enforce non-forwarding restriction through control of access to the digital letters and sending of images of digital letters. For example, the digital letters system tracks non-subscriber device selection of a link pointing to a digital letter, because the digital letters system receives that selection of the link and sends out the image of the digital letter to the non-subscriber device. The digital letters system can restrict the non-subscriber device to one time view or a selected number of views of the digital letter, through tracking and selected view count limits, and controlled access to the single copy of the digital letter in the digital letters database 1116. But, the digital letters system does not have access to the non-subscriber device email activity, and cannot directly monitor whether a non-subscriber has forwarded an email that includes the link and thus directly monitor non-subscriber forwarding.

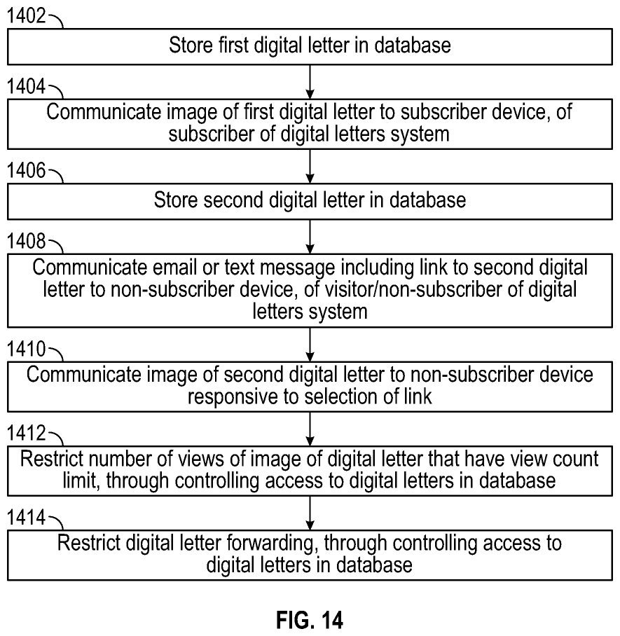

FIG. 14 is a flow diagram that illustrates a method of operation of a digital letters system according to an embodiment. The method can be practiced by a processor-based systems, including embodiments described herein and variations thereof. Such systems and methods of operation can be implemented using software executing on a processor, firmware, hardware, and combinations thereof, for practice of the described method and variations thereof.

In an action 1402, the system stores a first digital letter in a database. For example, a subscriber of the digital letters system composes a digital letter as the author, using an embodiment of the digital letters system, and the system stores the letter in a digital letters database.

In an action 1404, the system communicates an image of the first digital letter to a subscriber device, of a subscriber of the digital letters system. For example, the digital letters system sends an image of the first digital letter, to the subscriber device, which displays the image through a browser app on the screen of the subscriber device. The subscriber of the digital letters system can then view the image of the digital letter, while the digital letter remains as a single copy in the digital letters database. This is how a subscriber who is using a subscriber device communicates with a subscriber who is using a subscriber device. More specifically, an author subscriber using a subscriber device communicates with a recipient subscriber using a subscriber device. Also, this is how the recipient subscriber views the digital letter, more specifically the recipient subscriber views the image of the digital letter on a subscriber device.

In an action 1406, the system stores a second digital letter in a database. For example, a subscriber of the digital letters system composes a digital letter as the author, using an embodiment of the digital letters system, and the system stores the letter in the digital letters database.

In an action 1408, the system communicates an email or text message, which includes a link to the second digital letter, to a non-subscriber device that is a user device of a visitor or non-subscriber of the digital letters system. For example, the author that has composed the second digital letter is a subscriber of the digital letters system, and the recipient for the second digital letter is a non-subscriber of the digital letters system. The digital letters system is able to communicate the second digital letter to the non-subscriber recipient, through sending an email or text message that includes a link to the second digital letter. This is how a subscriber communicates with a non-subscriber. More specifically, an author subscriber who is using a subscriber device communicates with a recipient non-subscriber who is using a non-subscriber device.

In an action 1410, the system communicates an image of the second digital letter to the non-subscriber device, responsive to selection of the link. For example, the non-subscriber receives, on the non-subscriber device, the email or text message that includes the link to the second digital letter. The non-subscriber selects the link, which is seen in the email or text message that is displayed on the screen of the non-subscriber device, through an email app or text message app. Upon the non-subscriber selecting the link, which event is communicated to the digital letters system, the digital letters system sends the image of the second digital letter to the non-subscriber device. The non-subscriber device displays the image of the second digital letter, for example through a browser app and the screen of the non-subscriber device. Meanwhile, the second digital letter itself remains as a single copy in the digital letters database. This is how the recipient non-subscriber views the digital letter, more specifically the non-subscriber views the image of the digital letter on a non-subscriber device.

In an action 1412, the system restricts the number of views of images of digital letters that have a view count limit, through controlling access to digital letters in the database. For example, a digital letter could have a view count limit of one time view (OTV), or a selected number of views, as arranged through subscriber selection upon composing a digital letter as author using the digital letters system. View count limit for one time view or other selected number of views could be enforced for non-subscriber viewing, subscriber viewing, or both, in various embodiments. Views of the digital letter are tracked by the digital letters system, for example using a view counter and a view count limit (see FIG. 1 view counts 132). If a recipient (subscriber in some embodiments, or non-subscriber in some embodiments) attempts to view the digital letter in excess of the specified view count limit, the digital letters system does not send an image of the digital letter for display on the respective user device. This mechanism is applicable both to digital letters sent to a recipient that is a subscriber of the digital letters system, and digital letters sent to a recipient that is a non-subscriber of the digital letters system, in various embodiments. In both cases, the system controls whether or not to send an image of the digital letter to the recipient, by tracking link selection events and correspondingly controlling access to the digital letter in the database in accordance with a view count limit.

In an action 1414, the system restricts digital letter forwarding, through controlling access to digital letters in the database. For example, a digital letter sent (whether to a subscriber or non-subscriber recipient) with no forwarding (NF) does not have a forwarding selector, as a live selector, in the image of the digital letter that is sent to the user device. The only access to the digital letter itself that the recipient has is through the link to the digital letter, which the digital system interprets as to whether or not to send an image of the digital letter to the user device from which the link was selected. In case of forwarding control, the digital letters system sends an image of the digital letter to a subscriber or non-subscriber device when forwarding is allowed and the recipient of a forwarded digital letter selects to view the digital letter. For example, a subscriber of the digital letters system selects to view the digital letter by selecting the corresponding entry in the inbox in the digital letters personal account screen. Or, a non-subscriber of the digital letters system selects to view the digital letter by clicking on (e.g., selecting) the link in the email or text message. In both cases, the digital letters system, when forwarding is allowed, sends an image of the digital letter to the respective user device for display through the browser app and screen of the user device. In both cases, the digital letters system, when forwarding is not allowed, declines to send an image of the digital letter to the user device for display.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A digital letters system, comprising:
a network-connectable server;
a digital letters database, accessible by the server; and
a processor, of the server, configured to:
store, in the digital letters database, a first digital letter created by an author who is a subscriber to the digital letters system, the first digital letter having a designated recipient who is also a subscriber to the digital letters system; and
communicate, via a network, from the digital letters system to a recipient subscriber device, an image of the first digital letter, causing the image of the first digital letter to appear on the recipient subscriber device while the first digital letter itself remains as a single copy in the digital letters database, wherein the image of the first digital letter is communicated in response to (i) the author subscriber selecting to send the first digital letter to the recipient subscriber, and (ii) the recipient subscriber selecting to view the first digital letter stored on the digital letters database.

2. The digital letters system of claim 1, wherein the processor of the server is further configured to:
store, in the digital letters database, a second digital letter created by a respective author who is a subscriber to the digital letters system, the second digital letter having a designated recipient who is a non-subscriber to the digital letters system;
communicate, via the network, from the digital letters system to a recipient non-subscriber device, email or text message that includes a link to the second digital letter, causing the message including the link to appear on the recipient non-subscriber device; and
communicate, via the network, from the digital letters system to the recipient non-subscriber device, an image of the second digital letter, causing the image of the second digital letter to appear on the recipient non-subscriber device while the second digital letter itself remains as a respective single copy in the digital letters database, wherein the image of the second digital letter is communicated in response to (i) the respective author subscriber selecting to send the second digital letter to the recipient non-subscriber, and (ii) the recipient non-subscriber selecting the link on the recipient non-subscriber device to view the second digital letter stored on the digital letters database.

3. The digital letters system of claim 2, wherein the processor of the server is further configured to:
track, in the digital letters database, a number of views for each digital letter that has an associated view count limit; and
deny further viewing of a digital letter on a user device when the number of views for that digital letter meets the associated view count limit, in response to a request for the further viewing of that digital letter on the user device.

4. The digital letters system of claim 3, wherein the processor of the server is further configured to:
use one time view (OTV) as the view count limit.

5. The digital letters system of claim 2, wherein the processor of the server is further configured to:
track, in the digital letters database, forwarding chains for digital letters that are forwarded;
communicate tracking information of a forwarding chain to a user device for display thereupon, in response to a request by a user of the digital letters system; and
restrict forwarding for each digital letter for which no forwarding (NF) is selected.

6. The digital letters system of claim 2, wherein the processor of the server is further configured to:
store digital letters in private digital letters boxes in tables in the digital letters database.

7. The digital letters system of claim 2, wherein the processor of the server is further configured to:
store digital letters, drafts, attachments, groups, group members, digital letter view counts, recipient tracking, and pointers thereamong, in tables in the digital letters database; and
maintain a membership database in association with the digital letters database.

8. The digital letters system of claim 1, wherein:
the image of the first digital letter is to appear on the recipient subscriber device via a browser app, with the digital letters database tracking a number of views of the image of the first digital letter.

9. The digital letters system of claim 2, wherein:
the message including the link to the second digital letter is to appear on the recipient non-subscriber device via an email app or a text message app; and
the image of the second digital letter is to appear on the recipient non-subscriber device via a browser app, with the digital letters database tracking a number of views of the image of the second digital letter.

10. The digital letters system of claim 1, wherein the processor of the server is further configured to:
generate, by the digital letters system, a user interface for a subscriber to author and send a digital letter to a recipient subscriber, wherein the digital letter is to be stored in the digital letters database accessible by the digital letters system; and
communicate the user interface from the digital letters system to an author subscriber device, causing the user interface to appear on the author subscriber device for the subscriber to author and send the digital letter, wherein the user interface has a digital letter composition region, a one time view selector operable to restrict number of views of the digital letter by the recipient subscriber, and a send with no forwarding selector operable to prevent forwarding of the digital letter by the recipient subscriber.

11. A processor-based method of operation of a digital letters system, the method comprising:
storing, in a digital letters database accessible by the digital letters system, a first digital letter created by an author who is a subscriber to the digital letters system, the first digital letter having a designated recipient who is also a subscriber to the digital letters system; and
communicating, via a network, from the digital letters system to a recipient subscriber device, an image of the first digital letter, causing the image of the first digital letter to appear on the recipient subscriber device while the first digital letter itself remains as a single copy in the digital letters database, wherein the image of the first digital letter is communicated in response to (i) the author subscriber selecting to send the first digital letter to the recipient subscriber, and (ii) the recipient subscriber selecting to view the first digital letter stored on the digital letters database.

12. The method of claim 11, further comprising:
storing, in the digital letters database, a second digital letter created by a respective author who is a subscriber to the digital letters system, the second digital letter having a designated recipient who is a non-subscriber to the digital letters system;
communicating, via the network, from the digital letters system to a recipient non-subscriber device, email or text message that includes a link to the second digital letter, causing the message including the link to appear on the recipient non-subscriber device; and
communicating, via the network, from the digital letters system to the recipient non-subscriber device, an image of the second digital letter, causing the image of the second digital letter to appear on the recipient non-subscriber device while the second digital letter itself remains as a respective single copy in the digital letters database, wherein the image of the second digital letter is communicated in response to (i) the respective author subscriber selecting to send the second digital letter to the recipient non-subscriber, and (ii) the recipient non-subscriber selecting the link on the recipient non-subscriber device to view the second digital letter stored on the digital letters database.

13. The method of claim 12, further comprising:
tracking, in the digital letters database, a number of views for each digital letter that has an associated view count limit; and
denying further viewing of a digital letter on a user device when the number of views for that digital letter meets the associated view count limit, in response to a request for the further viewing of that digital letter on the user device.

14. The method of claim 13, further comprising using one time view (OTV) as the view count limit.

15. The method of claim 12, further comprising:
tracking, in the digital letters database, forwarding chains for digital letters that are forwarded;
communicating tracking information of a forwarding chain to a user device for display thereupon, in response to a request by a user of the digital letters system; and
restricting forwarding for each digital letter for which no forwarding (NF) is selected.

16. The method of claim 12, further comprising:
storing digital letters in private digital letters boxes in tables in the digital letters database.

17. The method of claim 12, further comprising:
storing digital letters, drafts, attachments, groups, group members, digital letter view counts, recipient tracking, and pointers thereamong, in tables in the digital letters database; and
maintaining a membership database in association with the digital letters database.

18. The method of claim 12, wherein:
the image of the first digital letter is to appear on the recipient subscriber device via a browser app, with the digital letters database tracking a number of views of the image of the first digital letter.

19. The method of claim 12, wherein:
the message including the link to the second digital letter is to appear on the recipient non-subscriber device via an email app or a text message app; and
the image of the second digital letter is to appear on the recipient non-subscriber device via a browser app, with the digital letters database tracking a number of views of the image of the second digital letter.

20. The method of claim 11, further comprising:
generating, by the digital letters system, a user interface for a subscriber to author and send a digital letter to a recipient subscriber, wherein the digital letter is to be stored in the digital letters database accessible by the digital letters system; and
communicating the user interface from the digital letters system to an author subscriber device, causing the user interface to appear on the author subscriber device for the subscriber to author and send the digital letter, wherein the user interface has a digital letter composition region, a one time view selector operable to restrict number of views of the digital letter by the recipient subscriber, and a send with no forwarding selector operable to prevent forwarding of the digital letter by the recipient subscriber.

21. A tangible, non-transitory, computer-readable media having instructions thereupon which, when executed by a processor, cause the processor to perform a method comprising:
storing, in a digital letters database accessible by the digital letters system, a first digital letter created by an author who is a subscriber to the digital letters system, the first digital letter having a designated recipient who is also a subscriber to the digital letters system; and
communicating, via a network, from the digital letters system to a recipient subscriber device, an image of the first digital letter, causing the image of the first digital letter to appear on the recipient subscriber device while the first digital letter itself remains as a single copy in the digital letters database, wherein the image of the first digital letter is communicated in response to (i) the author subscriber selecting to send the first digital letter to the recipient subscriber, and (ii) the recipient subscriber selecting to view the first digital letter stored on the digital letters database.

22. The computer-readable media of claim 21, wherein the method further comprises:
storing, in the digital letters database, a second digital letter created by a respective author who is a subscriber to the digital letters system, the second digital letter having a designated recipient who is a non-subscriber to the digital letters system;
communicating, via the network, from the digital letters system to a recipient non-subscriber device, email or text message that includes a link to the second digital letter, causing the message including the link to appear on the recipient non-subscriber device; and
communicating, via the network, from the digital letters system to the recipient non-subscriber device, an image of the second digital letter, causing the image of the second digital letter to appear on the recipient non-subscriber device while the second digital letter itself remains as a respective single copy in the digital letters database, wherein the image of the second digital letter is communicated in response to (i) the respective author subscriber selecting to send the second digital letter to the recipient non-subscriber, and (ii) the recipient non-subscriber selecting the link on the recipient non-subscriber device to view the second digital letter stored on the digital letters database.

23. The computer-readable media of claim 22, wherein the method further comprises:
tracking, in the digital letters database, a number of views for each digital letter that has an associated view count limit; and
denying further viewing of a digital letter on a user device when the number of views for that digital letter meets the associated view count limit, in response to a request for the further viewing of that digital letter on the user device.

24. The method of claim 23, wherein the method further comprises using one time view (OTV) as the view count limit.

25. The computer-readable media of claim 22, wherein the method further comprises:
tracking, in the digital letters database, forwarding chains for digital letters that are forwarded;
communicating tracking information of a forwarding chain to a user device for display thereupon, in response to a request by a user of the digital letters system; and
restricting forwarding for each digital letter for which no forwarding (NF) is selected.

26. The computer-readable media of claim 22, wherein the method further comprises:
storing digital letters in private digital letters boxes in tables in the digital letters database.

27. The computer-readable media of claim 22, wherein the method further comprises:
storing digital letters, drafts, attachments, groups, group members, digital letter view counts, recipient tracking, and pointers thereamong, in tables in the digital letters database; and
maintaining a membership database in association with the digital letters database.

28. The computer-readable media of claim 22, wherein the method further comprises:
generating, by the digital letters system, a user interface for a subscriber to author and send a digital letter to a recipient subscriber, wherein the digital letter is to be stored in the digital letters database accessible by the digital letters system; and
communicating the user interface from the digital letters system to an author subscriber device, causing the user interface to appear on the author subscriber device for the subscriber to author and send the digital letter, wherein the user interface has a digital letter composition region, a one time view selector operable to restrict number of views of the digital letter by the recipient subscriber, and a send with no forwarding selector operable to prevent forwarding of the digital letter by the recipient subscriber.

29. A server-based method of operation of a digital letters system, the method comprising:
generating, by a server of the digital letters system, a user interface for a subscriber to author and send a digital letter to a recipient subscriber, wherein the digital letter is to be stored in a digital letters database accessible by the server; and
communicating, by the server, the user interface from the digital letters system to an author subscriber device, causing the user interface to appear on the author subscriber device for the subscriber to author and send the digital letter, wherein the user interface has a digital letter composition region, a one time view selector operable to restrict number of views of the digital letter by the recipient subscriber, and a send with no forwarding selector operable to prevent forwarding of the digital letter by the recipient subscriber.
